(19) United States
(12) Patent Application Publication
(10) Pub. No.: US 2016/0142262 A1
(43) Pub. Date: May 19, 2016

(54) MONITORING A COMPUTING NETWORK

(71) Applicants: Marc Philipp WERNER, Boeblingen (DE); Balagurunathan RAJAGOPAL, Bangalore (IN); Norbert ANDRES, Boeblingen (DE); Frank VOSSELER, Boeblingen (DE); HEWLETT-PACKARD DEVELOPMENT COMPANY, L.P., Houston, TX (US)

(72) Inventors: Marc Phillip Werner, Boeblingen (DE); Balagurunathan Rajagopal, Bangalore (IN); Norbert Andres, Boeblingen (DE); Frank Vosseler, Boeblingen (DE)

(73) Assignee: Hewlett Packard Enterprise Development LP, Houston, TX (US)

(21) Appl. No.: 14/897,588

(22) PCT Filed: Jun. 17, 2013
(86) PCT No.: PCT/IN2013/000373

§ 371 Date: Dec. 10, 2015

(51) Int. Cl. H04L 12/24

(52) U.S. Cl. CPC H04L 41/12; H04L 41/0843; H04L 41/22; H04L 41/0813

(57) ABSTRACT

A computer-implemented method of monitoring a computing network includes identifying a topology pattern in a computing network. The method also includes assigning a management template for a configuration item type of the topology-pattern. The method further includes applying the management template to a configuration item instance of the configuration item type.

### BACKGROUND

A computing network can include thousands of network items configured to interact with each other. The network items can include software, models, plans, formal documentation such as process documentation, service level agreements (SLAs), servers, storage, routers, switches, and processing units, among others. These network items are monitored for changes that can affect the management of the network items.

### BRIEF DESCRIPTION OF THE DRAWINGS

Certain examples are described in the following detailed description and in reference to the drawings, in which:

FIG. 1 is a block diagram of an example of a computing system;

FIG. 2 is a block diagram of an example of a management template;

FIG. 3 is an illustration of an example of a monitoring aspect;

FIG. 4 is a block diagram of an example of a topology-pattern based monitoring system and a monitored application service;

FIG. 5 is a block diagram of an example of a topology-pattern based monitoring system;

FIG. 6 is a block diagram of a topology-pattern based monitoring system configuring an agent-less monitoring application;

FIG. 7 is a process flow diagram of an example of a method of configuring a monitoring system;

FIG. 8 is a process flow diagram of a example of a method of configuring a monitoring system;

FIG. 9 is a process flow diagram of an example of method of reconfiguring a monitoring system; and

FIG. 10 is a process flow diagram of an example of a method of reconfiguring a monitoring system.

### DETAILED DESCRIPTION OF SPECIFIC EXAMPLES

Techniques described herein relate generally to monitoring and managing a computing network. Information technology (IT) environments can include several thousand hardware and software elements, as well as services that are sourced from internal or external providers. These elements and services are managed by a management system. This management system may be reconfigured whenever an element or service in the IT environment changes. IT environments, such as virtualization technologies and on-demand provisioning of new systems, application, and, networks, have introduced a high frequency of changes in the IT environments. These changes increase the challenge in managing services in a timely, effective, low cost manner.

When monitoring a service or element, the element is considered in the context of the environment, rather than in isolation. For example, an application of a service can include several components, such as a server, middleware, and a database, among others. The components of the application interact with each other and are thus treated in a holistic fashion. The context of the environment is considered because the role of an element in a service can influence how the element is managed. For example, the disk I/O on a database server include more stringent controls than an application server machine of an application.

Current monitoring systems can be node-centric, configuring the monitoring system in the context of the monitored server. However, node-centric monitoring systems employ human users to configure the monitoring system, and to activate the appropriate monitoring for a given element or service. As such the efficiency of the monitoring system depends on the users' knowledge of where and how an application and the application's infrastructure and services are deployed, as well as on the users' understanding of which applications are running on each node.

Node-centric monitoring systems can be effective for simple scenarios. However, node-centric monitoring systems are inefficient for complex IT environments. For example, in dynamic IT environments, a delay can occur between the occurrence of a change and a user becoming aware of the change and updating the monitoring system. A delay between changes in the IT environment and adjustment of the monitoring system can lead to problems such as false alerts or failing to monitor a new element. A false alert is a report of a service that is down, when the service is decommissioned. in addition, node-centric monitoring systems can lack the ability to model the role context of a managed element. By not modeling the role context of a managed element, the node-centric monitoring systems are unable to provide the context to a user, depriving the user of full information when configuring how a server is to be managed.

By monitoring the topology patterns (layouts and interconnections among network items in the computing network) of an IT environment, a monitoring system can automatically identify changes in the IT environment and configure the monitoring system, rather than relying on human users. By automating the monitoring system, the efficiency of the monitoring system can be increased, while simultaneously decreasing the costs of maintaining the monitoring system.

A topology-pattern based monitoring system can automatically identify topology patterns that form the complex applications of a computing network and configure management and monitoring of the computing network without user intervention. The topology-pattern based monitoring system can analyze a representation of the computing network in a configuration management database (“CMDB”). The computing network can be dynamic and change with modifications, additions, or exclusions to the network items. Therefore the topology-pattern monitoring system can be designed to virtually display the computing network's topology patterns according to the latest updates in the computing network, and configure the monitoring of the computing network according to these changes.

As used herein, the term “monitoring topology pattern” refers to a definition of the structure of a composite IT system that can exist one or more times in an IT network. For example, a topology pattern can describe that an Application Service includes an Application Server which runs on a Node, and the Application Server uses a Database which runs on another Node. This definition is the topology pattern.

The topology-pattern based monitoring system can automatically query the configuration information for network items from the configuration items or configuration types in the CMDB. The topology-pattern based monitoring system can be provisioned to reflect the configuration items or configuration item types in a computing system. Furthermore, by monitoring updates in the CMDB, the topology-pattern based monitoring system can dynamically update the monitoring configuration to reflect changes in configuration item types or configuration items as they occur in the computing network.

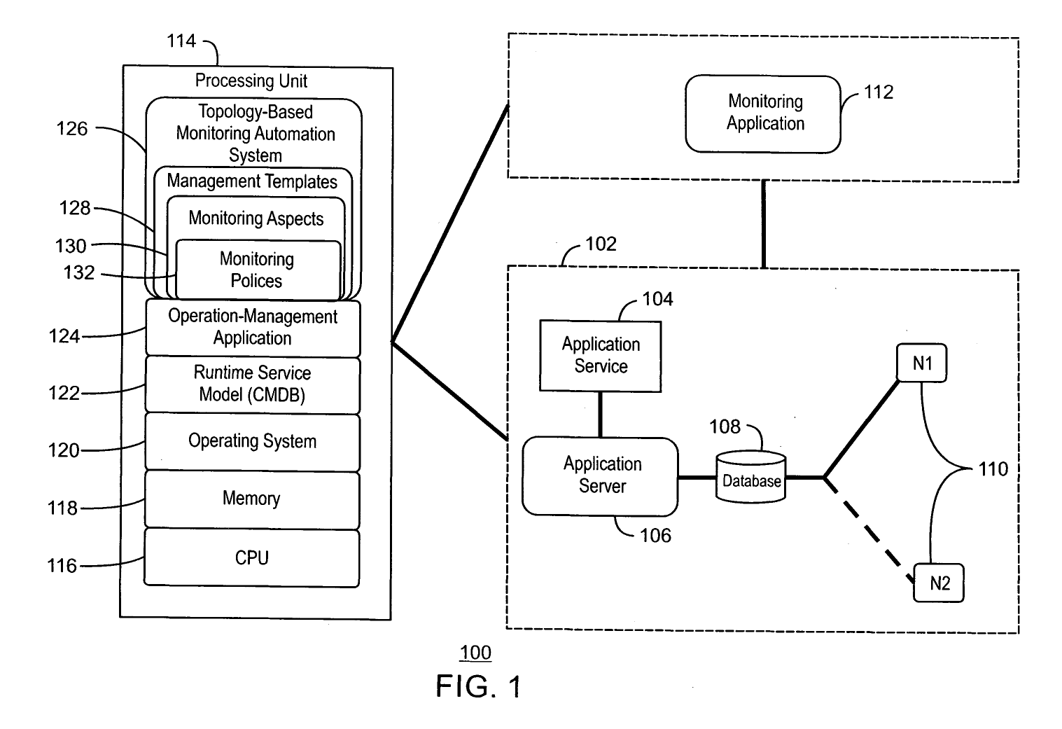

FIG. 1 is a block diagram of an example of a computing system. The computing system 100 includes a computing network 102. The computing network can include an application service 104 deployed on an application server 06. The application server 106 can be dependent on a database 108 to store data. The application server 106 and database 106 can run on a node or a plurality of nodes 110. For example, the application service 104 can be a web application that is deployed on a WebLogic server 106 running on node N1. The WebLogic server 106 can include a dependency to a MySQL database 108, running on node N2.

The computing system 100 can include a monitoring application The monitoring application 112 monitors the IT elements of the computing network (102) according to its monitoring configuration. Among other things, the monitoring application checks the availability and performance of the service that each IT element delivers. For example, the monitoring application 112 checks the response time of the Application Service (104) and the CPU Utilization of the server 110.

The computing system 100 further includes a processing nit 114. The processing unit 114 can include a central processing unit (CPU) 116 to execute stored instructions, as well as a memory device 118 that stores instructions that are executable by the CPU 116. The CPU 116 can be a single core processor, a multi-core processor, or any number of other configurations Additionally, the processing unit 114 can include more than one CPU 116.

The processing unit 114 can include a memory 118. The memory 118 can include random access memory (RAM), read only memory (ROM), flash memory, or any other suitable memory system. For example, the memory 118 can include dynamic random access memory (DRAM). The processing unit 114 can also include an operating system 120. The operating system 120 can he stored on the memory 118.

The processing unit 114 further includes a runtime service model (RTSM) 122. The runtime service model 122 can be a configuration management database (CMDB), The runtime service model includes a model of a customers IT environment and is automatically or manually updated as changes in the IT environment occur.

Configuration items (CIs) are representations of IT elements or network items in the CMOS 122. Configuration items can include representations of software, models, plans, formal documentation such as process documentation, service level agreements (SLAs), servers, storage, routers, switches, processing units, and the like. The CIs can be represented in the CMDB with relationships like “component of”, “dependent on”, or “hosted on” to model the structure of managed application and topological relationships between IT components. CIs in the CMDB are typed so that similar items, such as different Unix hosts or MySQL database instances, share similar attributes and can be queried easily. Information about each configuration item can be recorded in a configuration record within the CMDB. A configuration record is a record containing the configuration details of a network item.

The CMDB can record the attributes of each configuration item, as well as its relationship with other configuration items. The configuration item types, as well as the configuration records, can collect information on the activities of network items that are relatively similar, while simultaneously identifying configuration information for each network item in conjunction with other network items in the computing network.

Furthermore, the CMDB can collect information for network items using network discovery methods and store the information, regarding a configuration item type. For example, the CMDB can be updated using discovery technologies that continuously scan the IT environment and data feeds for changes. Although examples discussed herein are discussed in connection with the CMDB, in some examples, different data storage devices can be used to store the configuration information.

The processing unit 114 also includes an operation-management application 124. The operation-management application 124 consolidates the monitoring information from one or more monitoring applications 112 and presents this availability/performance information to a group of users to facilitate the resolution of issues in the monitored IT network 102. The operation-management application uses the runtime service model (CMDB) 122 to provide model of the managed IT network 102. The operation-management application 124 also uses the topology based monitoring system 114 to configure the monitoring applications 112 to monitor the IT network 102 according to the needs of the operations management application 124.

The processing unit 114 further includes a topology-based monitoring system 126. The topology-based monitoring system 126 can be a subset of the operation management application 124 or the topology-based monitoring system 126 can he installed on the processing unit 114 as a standalone application. The topology-based monitoring system 126 can be implemented in a variety of processing environments.

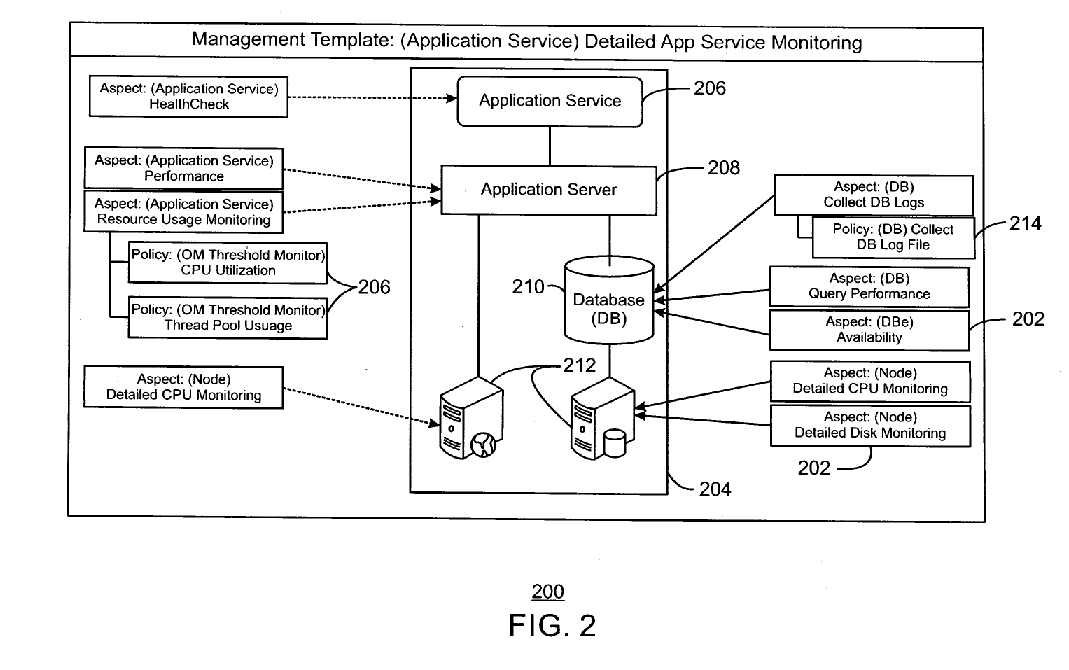

Furthermore, the topology-pattern based monitoring system 126 can include at least one management template 128. Each management template 1 can include monitoring aspects 130. Monitoring aspects 130 are monitoring packages of encapsulated monitoring configurations that are specific to a particular monitoring technology. The monitoring aspects 130 can be associated with a CI type to declare that the monitoring aspect can be applied to CI instances of this type in an IT environment. The monitoring aspects 130 include monitoring policies 132. A monitoring policy contains detailed settings (specific to a related type of monitoring application technology) that indicates to the monitoring application how IT elements shall be monitored (e.g. the file name and check interval of a logfile to be checked, or threshold levels for collected metrics). A monitoring application is instructed to monitor certain IT elements according to the policy by associating the policy with the IT element in the application's monitoring configuration. The structure and utility of the management templates 128 and their monitoring aspects 130 and monitoring policies 132 will be discussed further in connection with FIG. 2.

The topology-pattern based monitoring system 12 can apply the management templates 128 to existing topology pattern information collected from the RTSM 122 to determine a precise monitoring configuration for the computing network 102. For example, the topology-pattern based monitoring system 126 can use information collected from configuration items to apply corresponding management templates 128 to the topology-pattern monitoring system 126 in order to determine the monitoring configuration for the computing network 102 based on the topology patterns of the computing network 102.

It is to be understood that the block diagram of FIG. 1 is not intended to indicate that the computing system 100 is to include all of the components shown in FIG. 1 in every case. Further, any number of additional components can be included within the computing system 100, depending on the details of the specific implementation.

FIG. 2 is a block diagram of an example of a management template. The management template 200 can provide an abstraction on top of the monitoring aspects 202 to simplify monitoring of the network items of the computing network. The management template 200 defines which monitoring aspects 202 are to be applied to each IT component in the topology patterns 204 of an application. Each management template 200 includes a topology pattern 204 and an aspect set 202. Each topology pattern 204 includes representations of the network items to illustrate the relationship between the network items of the computing network. The topology pattern 204 illustrates that an application service 206 is deployed on an application server 208. The topology pattern 204 further illustrates the application server 208 can be dependent on a database 210 to store data. The topology pattern 204 further illustrates that the application server 208 and the database 210 can run on a node or a plurality of nodes 212. The aspect set describes the type of monitoring and the CI to which the monitoring is to be applied.

The management template 200 lists the aspect sets 202 included in the management template 200. The aspect sets 202 address each component of a composite IT system. For example, the management template 200 can include aspect sets 202 associated with the application service, the application server, the database, and the, nodes of the topology pattern. Associating an aspect 202 to an object of the topology pattern 204 in the management template 200 indicates that the respective aspect 202 is applied to monitor various features of each component in the IT network, if the component matches the topology pattern 204 of the management template 200. For example, the management template 200 can include an aspect set 202 directed to monitoring performance of all application severs and an aspect set 202 directed to resource usage monitoring of all application severs that are used by an instance of an application service that is monitored by this management template 200.

The management template 200 can also include monitoring policies 214. The monitoring policies 214 can be associated with aspects 202. For example, Policy: (DB) collect DB Log File can be associated with Aspect: (DB) Collect DB logs. Monitoring policies 214 can be deployed when the associated aspects 202 are identified as related to a CI. The monitoring policies 214 contain detailed settings (specific to a related type of monitoring application technology) that indicate to the monitoring application how IT elements shall be monitored (e.g. the file name and check interval of a logfile to be checked, or threshold levels for collected metrics).

Furthermore, the management template 200 can be a predefined expression of topology-patterns 204 of a select set of configuration item types and the relationships between the configuration item types in a computing network. The predefined management templates 200 can permit a topology-pattern based monitoring system to promptly match the configuration of the configuration item types. The management templates 200 can also be used to include dynamic monitoring adjustments for changes in the computing network such as load balancing, recovery, and deployment configurations.

When network items are added, changed, or removed in the CMDB, or if relationships between network items change, the pattern recognition of the management template 200 can be activated. If the change allows a new pattern match, then the management template 200 is activated. However, if the management template 200 no longer matches, the management template 200 is deactivated. For example, if a new server is added to, a web cluster for load balancing reasons, the monitoring template 200 will recognize the new server as part of the web duster and will automatically monitor the new server correctly and in context.

In addition, the management template 200 can be modified and tailored by an operator for a specific computing network. For example, an operator monitoring the computing network can allocate specific monitoring aspects 202 to a particular configuration item type using at least one management template 200. The user can create or modify the monitoring aspects 202 according to the topology-patterns 204 of the computing network.

It is to be understood that the block diagram of FIG. 2 is not intended to indicate that the management template 200 is to include all of the components shown in FIG. 2 in every case. Further, any number of additional components can be included within the management template 200, depending on the details of the specific implementation.

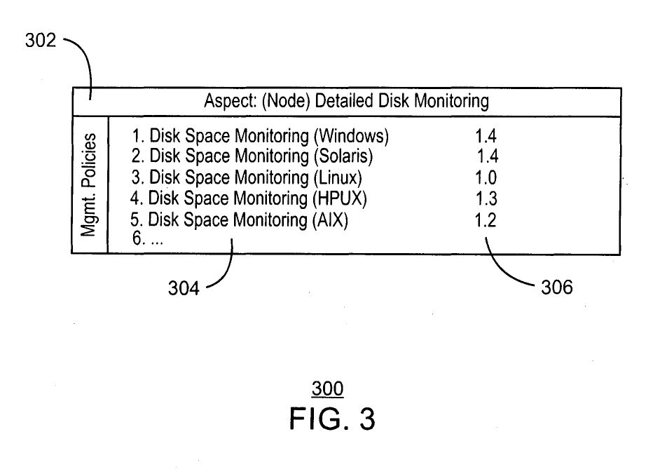

FIG. 3 is an illustration of an example of a monitoring aspect. The monitoring aspect 300 includes a definition 302. The definition 302 states the type of monitoring and the Configuration Item type to which the monitoring configuration is applicable. The aspect 300 also includes the management policies 304 of the aspect 300. The management policies 304 include constraint definitions that indicate which of the policies are to be in effect to monitor the IT element when the aspect is used to monitor that IT element. The constraint definitions act as filter expressions. For example, when the aspect 300 is applied a concrete instance of a node CI (i.e., a policy object in the configuration of the topology-based monitoring system is associated with an object (CI) in the CMDB that represents the node to be managed), constraint definitions on the OS attribute of the node CI can select the applicable policy based on the operating system of the node (e.g., Windows, Linux, etc), and thus only the correct monitoring policy is configured in the monitoring application to manage the node, The management aspect 300 also includes the revision version 306 of each management policy.

It is to be understood that the illustration of FIG. 3 is not intended to indicate that the management aspect 300 is to include all of the components shown in FIG. 3 in every case. Further, any number of additional components can be included within the aspect 300, depending on the details of the specific implementation.

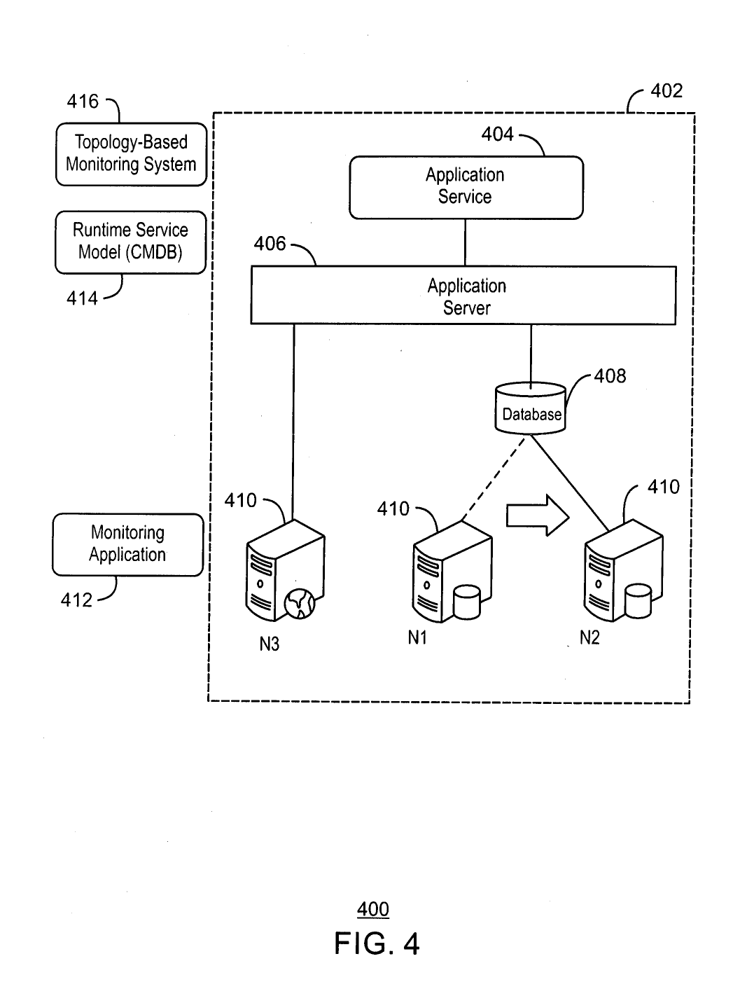

FIG. 4 is a block diagram of an example of a topology-pattern based monitoring system and a monitored application service. The topology-pattern based monitoring system 400 can monitor a computing network 402. The computing network 402 can include an application service 404 and an application server 406. The computing network can also include a database 408 and a node or a plurality of nodes 410. A monitoring application 412 monitors the IT elements of the computing network 402 according to the monitoring configuration. Among other things, the monitoring application 412 checks the availability and performance of the service that each IT element, delivers, such as the response time of the Application Service 404, and the CPU Utilization of the server 410.

The topology-based monitoring system 416 can redeploy a monitoring configuration after a change occurs in the computing network 402. For example, a change in the Computing network 402 can occur when a first network item N1 is replaced by a second network item (N2). N1 can be completely removed from the computing network 402 and replaced by N2, or the database 408 can be moved from server N1 to N2. Because N1 and N2 are represented as configuration items (CIs) in the runtime service model (CMDB) 414, the change in the configuration item is identified in the CMDB 414. For example, the change in configuration items can be identified through the use of discovery technologies that continuously scan the computing network 402 for changes.

When the change from N1 to N2 is identified, the topology-based monitoring system 416 can identify that the change matches the topology-pattern of a management template that is associated with the application service 404 of the computing network 402. When the topology-based monitoring system 416 identifies that the change matches the topology-pattern of the management template, the topology-based monitoring system 416 can automatically reconfigure the monitoring application 412 to adjust the monitoring configuration from monitoring N1 to monitoring N2.

In addition to adjusting the monitoring if a change within a topology pattern of a managed IT system is detected (e.g. moving the database from N1 to N2), the topology-based monitoring system 416 can assign at least one management template (not shown) to a new instance of an Application Service configuration item. The topology-pattern based monitoring system 416 can then apply the management template to the new application service, and configure the monitoring application to monitor the application service and all of the application service's IT components according to the definition of the management template.

It is to be understood that the block diagram of FIG. 4 is not intended to indicate that the topology-pattern based monitoring system 400 is to include all of the components shown in FIG. 4 in every case. Further, any number of additional components can be included within the topology-pattern based monitoring system 400, depending on the details of the specific implementation.

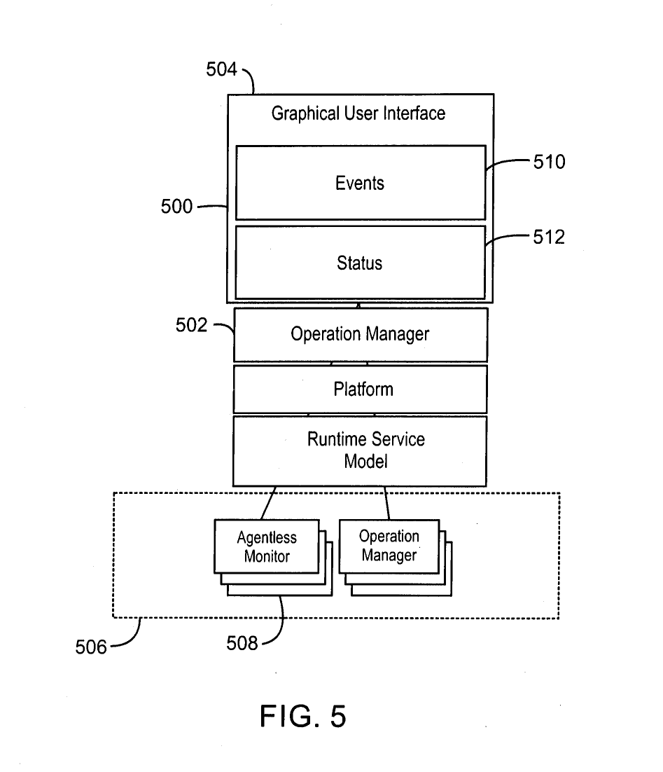

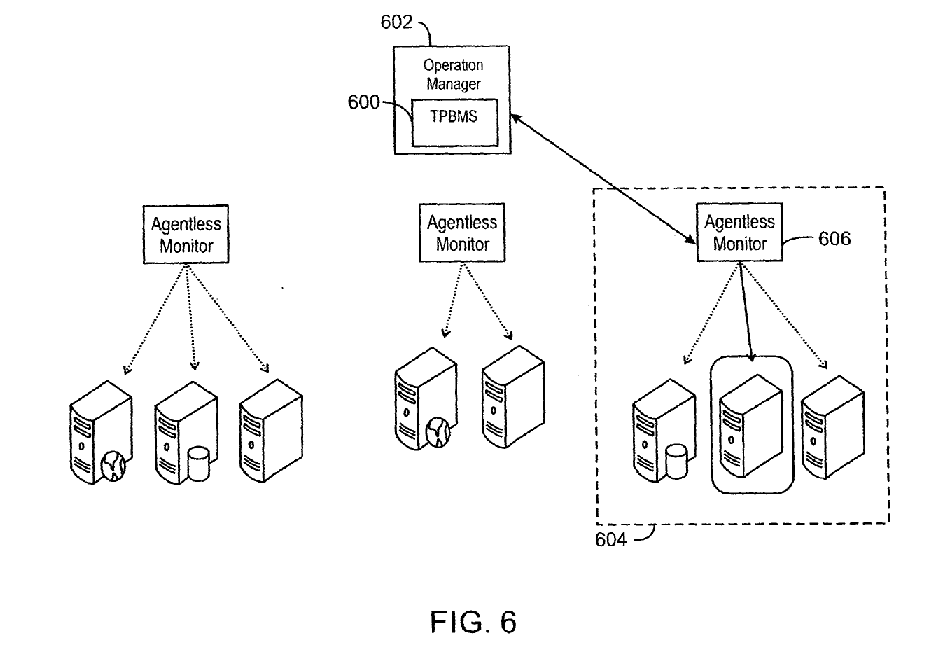

FIG. 5 is a block diagram of an example of a topology-pattern based monitoring system. The topology-pattern based monitoring system 500 can include a graphical user interface 504. The graphical user interface 504 can display monitoring information for at least one domain manager 506. The domain managers 506 can include agentless monitor 508 and other similar domain managers. Each agentless monitor 508 can manage a plurality of configuration items. The topology-pattern based monitoring system 500 described herein can operate in a stand-alone mode or in combination with the operation manager 502. The topology-pattern based monitoring system can configure a plurality of agentless monitors 304. The agentless monitor's interaction and management with the configuration item types will be explained further in FIG. 6.

The graphical user interface can include events 610 management and status 512 windows. The events 510 management window can display the health of the computing network, whereas the status 512 window can provide a focused view for each affected configuration item.

It is to be understood that the block diagram of FIG. 5 is not intended to indicate that the topology-pattern based monitoring system 500 is to include all of the components shown in FIG. 5 in every case. Further, any number of additional components can be included within the topology-pattern based monitoring system 500, depending on the details of the specific implementation.

FIG. 6 is a block diagram of a topology-pattern based monitoring system configuring an agentless monitoring application. According to some examples, the topology-pattern based monitoring system (TPBMS) 600 can configure monitoring products that operate in an agent based or an agent-less mode. The topology-pattern based monitoring system can run on the operation manager 602. An agent-based monitoring system is typically collocated with the managed IT element, whereas an agent-less monitoring application runs on a separate server and manages the IT element using remote access over a network connection. This remote access imposes an extra challenge for a topology-pattern based monitoring system 600, as the topology-pattern based monitoring system 600 not only determines which IT element to manage (based on the topology pattern), but also which monitoring system 606 to select that are responsible for monitoring the IT element 604. In the agent-less monitoring system, if a management template's topology pattern on an RTSM/CMDB indicates that the network item is to be monitored with a Particular monitoring policy as defined by the management template, the TPBMS 600 determines the correct agentless monitor.

It is to be understood that the block diagram of FIG. 6 is not intended to indicate that the topology-pattern based monitoring system 600 is to include all of the components shown in FIG. 6 in every case. Further, any number of additional components can be included within the topology-pattern based monitoring system 600, depending on the details of the specific implementation.

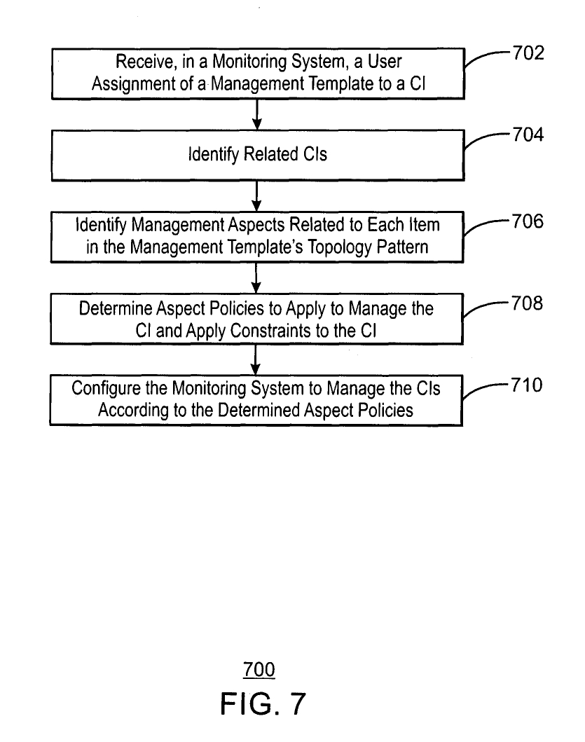

FIG. 7 is a process flow diagram of an example of a method of configuring a monitoring system. The method 700 can be implemented by a monitoring system, such as topology pattern-based monitoring system 126. At block 702, a user assignment of a management template to a CI can be received its a monitoring system. The management template can be assigned by an operator or automatically assigned. In some examples, multiple management templates can be assigned to a CI or a plurality of management templates can be assigned to a plurality of CIs.

At block 704, related CIs can be identified. The related CIs can be identified based on the management template's topology pattern. For example, the correct instance of a Database, the correct instance of an Application Server of an application, the nodes instance that hosts the Application Server, and the node that hosts the Database can be identified.

At block 706, monitoring aspects related to each item (CI) in the management template's topology pattern can be identified. Monitoring aspects are monitoring configurations and are based on recognized monitoring configurations in a computing network. The Monitoring aspects and their associated policies to be applied to manage the CI can be determined manually by an operator or automatically.

At block 708, policy, constraints from the monitoring aspect can be applied based on the CI (or other CIs related to the CI) and aspect policies to apply to manage the CI can be determined Applying the constraints ensures that only applicable policies (e.g. correct operating system) from the monitoring aspect will be used to monitor the CI. The constraints act as filters to choose an appropriate subset of policies from the monitoring aspect, such as based on the Operating System on which the managed IT elements runs.

At block 710, the monitoring application can be configured to manage the CIs according to the determined aspect policies. The topology pattern based monitoring system can determine all related configuration items according to the topology pattern, identify all aspects that are related to the network items in the particular topology context, and deploy the monitoring policies accordingly to the monitoring applications. In some examples, the topology-pattern based monitoring system can adjust the configuration of the management template according to an identified configuration item. Further, the topology can be updated so that the topology-pattern based monitoring system continuously reflects the latest state of the configuration items. In an example, the status of configuration items can be accessed via a graphical user interface.

It is to be understood that the process flow diagram of FIG. 7 is not intended to indicate that the method 700 is to include all of the blocks shown in FIG. 7 in every case. Further, any number of additional blocks can be included within the method 700, depending on the detail of the specific implementation.

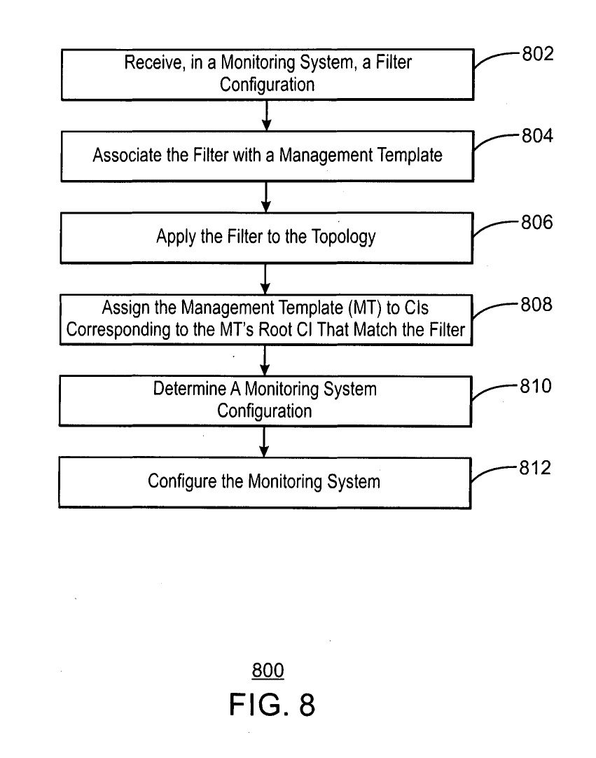

FIG. 8 is a process flow diagram of an example of a method of configuring a monitoring system. At block 802, a filter configuration can be received in a monitoring system. The filter acts as an automatic assignment of a management template to a configuration item. The filter can he configured by a user. The user can configure the filter to select a subset of objects of a CMDB.

At block 804, the filter can be associated with a management template. The filter can be associated with a management template by a user. In another example, the filter can be automatically associated with a management template. At block 806, the filter can be applied to the topology. The monitoring system can continuously apply the filter to the topology of the computing network.

At block 808, the management template (MT) can be assigned to CIs corresponding to the MT's root CI that match the filter. The MT can be assigned to all CIs that match the filter. For example, a filter can select all Application Service objects and their related customer object, where the customer importance is “high”. In this example, the filter returns a subset of the topology, and the monitoring system assigns the MT to all instances of “Application Service”, which is the MT's root CI.

At lock 810, a monitoring system configuration can be determined, For example, the monitoring system configuration can be determined as described in blocks 704-710 of method 700 described above. At block 812, the monitoring applications can be configured. The monitoring applications can be configured in accordance with the configuration determined in block 810.

It is to be understood that the process flow diagram of FIG. 8 is not intended to indicate that the method 800 is to include all of the blocks shown in FIG. 8 in every case. Further, any number of additional blocks can be included within the method 800, depending on the detail of the specific implementation.

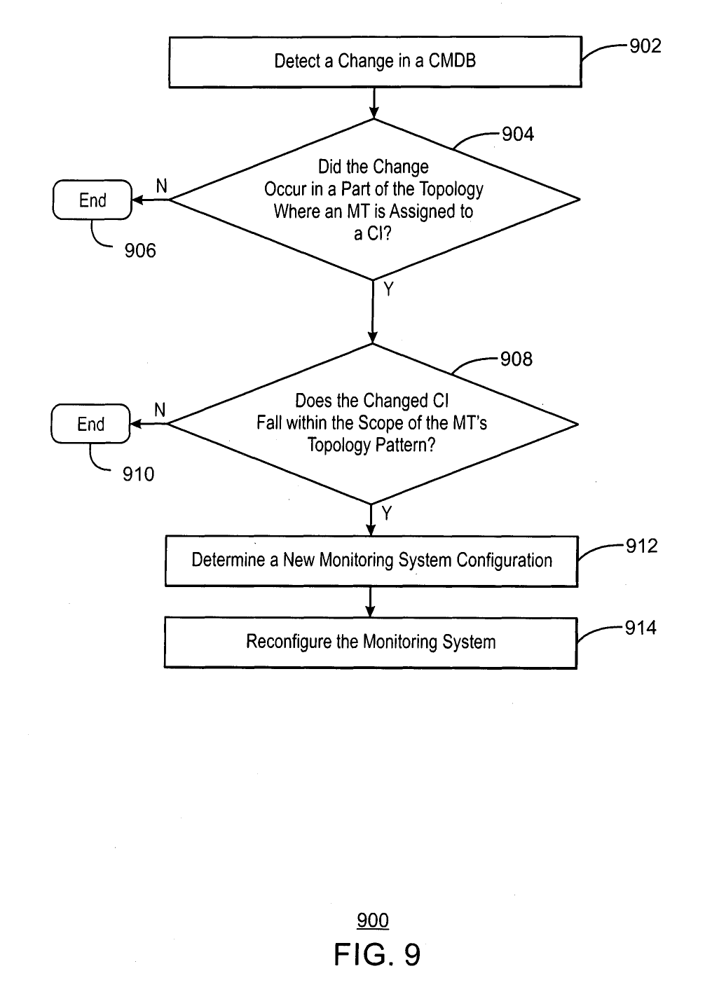

FIG. 9 is a process flow diagram of an example of a method of reconfiguring a monitoring system. At block 902, a change in a CMDB can be detected. The change in the CMDB corresponds to a change in the computing network. The change can include, for example, configuration changes, additions of network items, exclusions of network items, and software updates, among others. The change can be detected through the use of discovery technologies that continuously scan the computing network for changes.

At block 904, the monitoring system can determine if the change occurred in a part of the topology where a management template (MT) is assigned to a configuration item (CI). If the change did not occur in a part of the topology where an MT is assigned to a CI, the method will end at block 906.

If the change did occur in a part of the topology where an MT is assigned to a CI, at block 908, the monitoring system can determine if the changed CI fails within the scope of the MT's topology pattern. If the changed CI does not fall within the scope of the MT's topology pattern, the method will end at block 910. If the changed CI falls within the scope of the MT's topology pattern, at block 912 the monitoring system can determine a new monitoring system configuration. For example, the topology pattern based monitoring system can determine the new monitoring system configuration as described in method 700. At block 914, the monitoring system can be reconfigured.

It is to be understood that the process flow diagram of FIG. 9 is not intended to indicate that the method 900 is to include all of the blocks shown in FIG. 9 in every case. Further, any number of additional blocks can be included within the method 900, depending on the detail of the specific implementation.

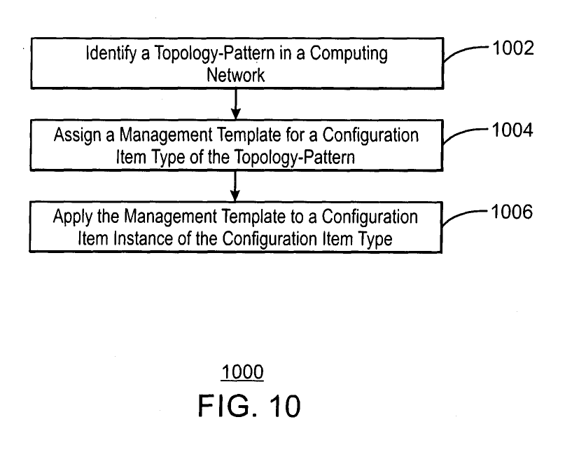

FIG. 10 is a process flow diagram of an example of a method of reconfiguring a monitoring system. The method 1000 can be implemented by a monitoring system, such as topology pattern-based monitoring system 126. At block 1002, a topology-pattern in a computing network can be identified.

At block 1004, a management template for a configuration item type of the topology-pattern can be assigned. The management template can be assigned by an operator or automatically assigned. In some examples, multiple management templates can be assigned to a CI or a plurality of management templates can be assigned to a plurality of CIs. At block 1006, the management template can be applied to a configuration item instance of the configuration item type.

It is to be understood that the process flow diagram of FIG. 10 is not intended to indicate that the method 1000 is to include all of the blocks show in FIG. 10 in every case. Further, any number of additional blocks can be included within the method 1000, depending on the detail of the specific implementation.

The present examples can be susceptible to various modifications and alternative forms and are being offered only for illustrative purposes. For example, the present techniques support both reading and writing operations to a data structure cache. Furthermore, it is to be understood that the present techniques are not intended to be limited to the particular examples described herein. Indeed, the scope of the appended claims is deemed to include all alternatives, modifications, and equivalents that are apparent to persons skilled in the art to which the disclosed subject matter pertains.

What is claimed is:

1. A computer implemented method of monitoring a computing network comprising:
identifying a topology-pattern in a computing network;
assigning a management template for a configuration item type of the topology-pattern; and
applying the management template to a configuration item of the configuration item type.

2. The method of claim 1, wherein preparing the management template comprises:
including, in the management template, a selected monitoring configuration; and
assigning the management template to a configuration item.

3. The method of claim 1, further comprising:
detecting a change in the computing network;
determining a new monitoring system configuration; and
reconfiguring the monitoring system based on the new monitoring system configuration.

4. The method of claim 1, wherein preparing the management template comprises preparing a plurality of management templates.

5. The method of claim 2, wherein selecting the monitoring configuration comprises selecting a plurality of monitoring configurations.

6. A monitoring system comprising:
at least one processor to:
access a management template for a configuration item type;
identify a topology-pattern in a computing network, the topology-pattern including the configuration item type; and
apply the management template to a configuration item instance of the configuration item type.

7. The monitoring system of claim 6, wherein the at least one processor is to:
select a monitoring configuration;
include, in the management template, the selected monitoring configuration; and
assign the management template to a configuration item.

8. The monitoring system of claim 6, wherein the at least one processor is to:
detect a change in the computing network;
determine a new monitoring system configuration; and
reconfigure the monitoring system based on the new monitoring system configuration.

9. The monitoring system of claim 6, the management template comprising a plurality of management templates.

10. The monitoring system of claim 6, the monitoring configuration comprising a plurality of monitoring configurations.

11. A tangible, non-transitory, computer-readable storage medium comprising code to direct a processor to:
identify a topology-pattern in a computing network;
assign a management template to a configuration item type of the topology-pattern; and
apply the management template to a configuration item instance of the configuration item type.

12. The medium of claim 11, comprising code to direct the processor to:
select a monitoring configuration;
include, in the management template, the monitoring configuration; and
assign the management template to a configuration item.

13. The medium of claim comprising code to direct the processor to:
detect a change in the computing network;
determine a new monitoring system configuration; and
reconfigure the monitoring system based on the new monitoring system configuration.

14. The medium of claim 11, comprising code to direct the processor to prepare a plurality of management templates.

15. The medium of claim 11, comprising code to direct the processor to select a plurality of monitoring configurations.
